(19) United States
(12) Patent Application Publication
(10) Pub. No.: US 2006/0166838 A1
(43) Pub. Date: Jul. 27, 2006

(54) Method of preparing microparticles

(76) Inventors: Ian Ralph Collins, Middlesex (GB); Simon Neil Duncum, Berkshire (GB)

Correspondence Address: NIXON & VANDERHYE, PC, 901 NORTH GLEBE ROAD, 11TH FLOOR, ARLINGTON, VA, 22203, US

(21) Appl. No.: 10/516,622

(22) PCT Filed: May 15, 2003
(86) PCT No.: PCT/GB03/02091

§ 371 Date: Dec. 3, 2004

(30) Foreign Application Priority Data
Jun. 13, 2002 (GB) 0213599.4

(51) Int. Cl. C09K 8/60

(52) U.S. Cl. 507/219

(57) ABSTRACT

A method of preparing microparticles comprising an aqueous solution or dispersion of an oil or gas field production chemical encapsulated in a continuous polymeric phase comprising a degradable polymer, which method comprises: (a) preparing a water in oil in water double emulsion or a water in oil in oil double emulsion having an internal aqueous phase comprising an aqueous solution or dispersion of the production chemical and an internal oil phase comprising a solution of a degradable polymer dissolved in a volatile organic solvent wherein the internal aqueous phase is dispersed in the internal oil phase of the double emulsion in the form of droplets having a mean diameter of less than 10 microns; and (b) at least in part evaporating the volatile organic solvent from the double emulsion such that the degradable polymer accumulates around the droplets of the internal aqueous phase and hardens to form microparticles comprising a continuous polymeric phase encapsulating the internal aqueous phase having a mean particle diameter of less than 10 microns.

This present invention relates to a method of preparing microparticles comprising an aqueous solution or dispersion of an oil or gas field production chemical, encapsulated in a continuous polymeric phase comprising a degradable polymer, and to their use in treating hydrocarbon bearing formations.

Scale inhibitors are used in production wells to stop scaling in the rock formation and/or in the production lines down hole and at the surface. Scale is a slightly soluble inorganic salt, such as barium or strontium sulphate, calcium carbonate, calcium sulphate or calcium fluoride. In the production of hydrocarbons from subterranean formations the deposition of scale on surfaces and production equipment is a major production problem. Scale build-up decreases permeability of the formation, reduces well productivity and shortens the lifetime of production equipment. In order to clean scaled-up wells and equipment it is necessary to stop the production i.e. by killing the well which is time-consuming and costly.

To minimise scale build-up an aqueous solution of a scale inhibitor may be injected by force into the formation via a production well-bore. After injection the production well is shut-in during which time the scale inhibitor is absorbed within the formation and the inhibitor is slowly desorbed into the fluids in the formation to inhibit scale deposition. After the shut-in period the production well is returned on stream. The fluids produced therefrom are analysed to determine the scale-inhibitor concentration. When the concentration of inhibitor in the fluids has reduced to a certain level then further treatments will be required. An aqueous-based scale inhibitor has a short lifetime of a few weeks. The continual need for such treatments is therefore costly, not only in terms of production shut down periods but also in the cost of the chemical scale inhibitor used.

Other water-soluble or water-dispersible inhibitors used in production well environments include corrosion inhibitors, hydrogen sulphide scavengers or hydrate inhibitors. These too may need shut-ins.

WO 93/22537 relates to microcapsules containing an oil field chemical where the microcapsules have a wall comprising gelatin and are stabilized by incorporation of an effective amount of a strong chelating agent. The microcapsules are prepared by any procedure or variation thereof wherein an oil field chemical is dispersed in a water-immiscible solvent, and then emulsified with an aqueous solution containing one or more macro colloids, in particular, gelatin, which are capable of undergoing simple or complex coacervation. In the process of coacervation, one or more of the macro colloids deposits itself around the dispersed droplets of the water immiscible solvent and treating agent The droplets are thereby completely encapsulated and sealed. The microcapsules are in the micron size range (e.g., 30-40 micron diameter)

U.S. Pat. No. 4,986,354 relates to placing an oil field chemical in microcapsules of the condensation product of hydroxyacetic acid monomer or a co-condensation product of hydroxyacetic acid and compounds containing other hydroxy-carboxylic acid- or hydroxycarboxylic acid moieties and thereafter introducing such microcapsules into an oil well bore and/or subterranean formation where the oil field chemicals are released in the presence of moisture to form oil and water soluble products. The microcapsules can be formed by any conventional chemical or physical encapsulation method, such as interfacial polymerization or coacervation. It is said that smaller, micron sized capsules will allow passage into and through reservoir pores to provide effective penetration of the chemical into the reservoir but there is no suggestion that sub-micron sized microcapsules maybe formed through the techniques of interfacial polymerization or coacervation.

U.S. Pat. No. 4,456,067 describes a process for inhibiting the formation of gas hydrates in producing gas wells by injecting microencapsulated inhibitors suspended in a hydrocarbon carrier fluid into a subterranean gas-bearing formation. Release of the hydrate inhibitor to the gas produced from the formation is effected by in situ degradation of the microcapsule wall and permeation of hydrate inhibitors through the microcapsule wall. It is said that the microcapsules are formed by any conventional chemical or physical microencapsulation method, such as, interfacial polymerization or coacervation. When formulating a microcapsule to degrade in situ, a polymeric material is chosen for the microcapsule wall which is either soluble in the formation fluids, the core fluid or both. Suitable polymers are said to include polytriflurochloroethylene and polyethylacrylate.

WO 02/12674 relates to a method of delivering a chemical to an oil or gas well, the method comprising associating the chemical with a carrier, and delivering the chemical plus carrier to the well. The chemical can be encapsulated by the carrier or otherwise entrapped by the carrier. The oilfield chemical can be entrapped in either liquid or solid form. The chemical is typically coated or otherwise associated with a carrier such as starch, flour or wax. While starch is a preferred entrapping or coating medium a range of other materials could be used including acrylic, carboxyvinyl polymers, polyester, polystyrene, polycaprolactone, polyvinyl acetate, polyamides, polyvinyl alcohol, polylactic acid, and polyglycolide. The entrapped oilfield chemicals can be rapidly released from the encapsulating and/or carrier medium as a result of either thermal degradation of the matrix and/or dissolution in oil or water. The release time of the chemical upon contact with the produced fluids could also be delayed depending upon the nature of the entrapment matrix.

There has now been found an improved method of encapsulating an aqueous solution of a water-soluble oil or gas field production chemical or an aqueous dispersion of a water-dispersible oil or gas field production chemical in microparticles, in particular, in microcapsules having a wall formed from a degradable polymeric material or in microspheres having a polymeric matrix formed from a degradable polymeric material. It has also been found that such microparticles may be injected into a formation through an injection well and may propagate through the formation to the near-well bore region of a production well where the oil or gas field production chemical, for example, a scale inhibitor is released from the microparticles through degradation of the polymeric material.

Thus, the present invention provides a method for preparing microparticles comprising an aqueous phase comprising an aqueous solution of a water-soluble oil or gas field production chemical or an aqueous dispersion of a water-dispersible oil or gas field production chemical encapsulated in a continuous polymeric phase comprising a degradable polymer, which method comprises:

a) preparing a water in oil in water double emulsion or a water in oil in oil double emulsion having an internal aqueous phase comprising an aqueous solution of a water-soluble oil or gas field production chemical or an aqueous dispersion of a water-dispersible oil or gas field production chemical and an internal oil phase comprising a solution of a polymer in a volatile organic solvent wherein the internal aqueous phase is dispersed in the internal oil phase of the double emulsion in the form of droplets having a mean diameter of less than 10 microns; and

b) at least in part evaporating the volatile organic solvent from the double emulsion such that the polymer accumulates around the droplets of the internal aqueous phase and hardens to form microparticles comprising a continuous polymeric phase encapsulating the internal aqueous phase having a mean particle diameter of less than 10 microns.

Preferably, the internal aqueous phase is dispersed in the internal oil phase of the water in oil in water double emulsion or the water in oil in oil double emulsion in the form of droplets having a mean diameter of less than 5 microns, more preferably, less than 1 micron. Accordingly, the microparticles preferably have a mean diameter of less than 5 microns, more preferably, less than 1 micron.

Suitably, the microparticles are microcapsules or microspheres.

By microcapsule is meant a particle having a well-defined core and a well-defined envelope or wall. The core comprises an aqueous solution of a water-soluble oil or gas field production chemical (hereinafter “aqueous solution) or an aqueous dispersion of a water-dispersible oil or gas field production chemical (hereinafter “aqueous dispersion”). The wall of the microcapsule is made of a continuous, polymeric phase comprising a degradable polymer. The wall of the microcapsule may be porous or non-porous. Where the wall of the microcapsule is porous, the oil or gas field production chemical may permeate through the microcapsule wall. Suitably, the microcapsule is substantially spherical. Preferably, the wall of the microcapsule has a thickness of 10 to 50 nm, preferably 15 to 30 nm.

By microsphere is meant a particle comprising a continuous polymeric matrix comprising a degradable polymer encapsulating the aqueous solution or aqueous dispersion at either a macroscopic (droplets) or molecular (dissolution) level. Preferably, a plurality of droplets of the aqueous solution or aqueous dispersion may be encapsulated in the polymeric matrix. Unlike a microcapsule, the polymeric microsphere matrix has no well-defined wall. The polymeric matrix may be porous or non-porous. The polymeric matrix may comprise two or more miscible polymers. The microsphere may be substantially spherical or may be of an irregular shape.

According to a first preferred embodiment of the present invention there is provided a method for preparing microparticles comprising an aqueous phase comprising an aqueous solution of a water-soluble oil or gas field production chemical or an aqueous dispersion of a water-dispersible oil or gas field production chemical encapsulated in a continuous polymeric phase comprising a degradable polymer, which method comprises:

a) mixing an aqueous phase comprising an aqueous solution of a water-soluble oil or gas field production chemical or an aqueous dispersion of a water-dispersible oil or gas field production chemical with a primary oil phase comprising a solution of a polymer in a volatile organic solvent in the presence of a water-soluble surfactant to form a water in primary oil emulsion having the aqueous phase dispersed in the primary oil phase in the form of droplets having a mean diameter of less than 10 microns, preferably less than 5 microns, more preferably less than 1 micron;

b) mixing the water in primary oil emulsion with a secondary oil phase in the presence of an oil-soluble surfactant to form a water in primary oil in secondary oil double emulsion; and

c) at least in part evaporating the volatile organic solvent from the water in primary oil in secondary oil double emulsion such that the polymer accumulates around the droplets of the aqueous phase and hardens to form microparticles comprising a continuous polymeric phase encapsulating the aqueous phase having a mean particle diameter of less than 10 microns, preferably less than 5 microns, more preferably less than 1 micron.

Without wishing to be bound by any theory, the water in primary oil in secondary oil double emulsion formed in step b) comprises discrete droplets of the water in primary oil emulsion dispersed in the secondary oil phase. Where it is desired to form microcapsules, each discrete dispersed droplet of the water in primary oil emulsion preferably contains a single droplet of the internal aqueous phase. Upon evaporation of the volatile solvent, the polymer accumulates around the single droplet of the internal aqueous phase to form a hardened polymeric wall. Where it is desired to form microspheres, each discrete droplet of the water in primary oil emulsion preferably contains a plurality of droplets of the internal aqueous phase. Upon evaporation of the volatile solvent, the polymer accumulates around the plurality of droplets of the internal aqueous forming a hardened polymeric matrix encapsulating said droplets.

Suitably, the dispersed droplets of the water in primary oil emulsion have a mean diameter of less than 50 microns, preferably, less than 25 microns, more preferably less than 10 microns, most preferably, less than 5 microns, for example, less than 2 microns. Preferably, the droplet(s) of internal aqueous phase in the dispersed droplets of the water in primary oil emulsion have a mean diameter of less than 1 micron, more preferably in the range 100 to 750 nm, most preferably in the range 200 to 500 nm, for example, in the range 200 to 300 nm.

The intermediate water in primary oil emulsion may be made in a basic four step approach. The first step is to form either (i) an aqueous solution of a suitable water-soluble oil or gas field chemical or (ii) an aqueous dispersion of a suitable water-dispersible oil or gas field chemical.

The water which is used to form the aqueous solution or aqueous dispersion may be pure water, tap water, deionised water, seawater, sulphate reduced seawater or a synthetic brine. It will be appreciated that the aqueous solution or aqueous dispersion may also include liquids other than water such as alcohols (for example, methanol or ethanol), or glycols (for example, butyltriglycol ether). Such liquids lower the interfacial tension between the aqueous phase and the primary oil phase of the intermediate water in primary oil emulsion thereby aiding formation of sub-micron sized droplets of aqueous phase. Without wishing to be bound by any theory, the alcohol may be extractable into the primary oil phase of the water in primary oil emulsion.

The second step is to blend the aqueous solution or aqueous dispersion with a suitable water-soluble surfactant. The water-soluble surfactant must have a hydrophilic/lipophilic balance (HLB) suited to the other liquids present in the water in oil emulsion. Preferably, the water-soluble surfactant has an HLB value of 8 to 19, more preferably 10 to 18, most preferably 13 to 18. Examples of suitable water-soluble surfactants include aliphatic alcohol alkoxylates, alkylphenol ethoxylates, C₁₁₋₁₅ pareth-15, C₁₁₋₁₅ pareth-20, C₁₁ oxo alcohol ethoxylates, fatty alcohol ethoxylates (for example, C_{12/14} or C₁₃ fatty alcohol ethoxylates), C₁₂₋₁₅ pareth-16, C₁₂₋₁₅ pareth-23, C₁₃₋₁₅ pareth-20, C₉₋₁₁ pareth-10, C₉₋₁₁ pareth-12, C₉₋₁₁ pareth-20, C_{16/18} fatty alcohol polyglycol ethers, cetoleth-25, cocamidopropyl PG-ammonium chloride phosphate, ethoxylated nonylphenols, nonoxynol-15, nonoxynol-20, nonoxynol-30, nonyl nonoxynol-24, nonylphenol ethoxylate, oleth-15, PEG-10-PPG-10 glyceryl stearate, PEG-15 C₁₃ oxo-alcohol, PEG-15 tridecanol, PEG-20 C₁₃ oxo-alcohol, PEG-20 dilaurate, PEG-20 laurate, PEG-20 oleate, PEG-20 stearate, PEG-20 syn primary C₁₃₋₁₅ alcohol, PEG-30 straight chain synthetic C₁₃₋₁₅ fatty alcohols, PEG-32 delaurate, PEG-32 dioleate, PEG-32 distearate, PEG-32 oleate, PEG -12 C₁₃ oxo-alcohol, sucrose laurate, sucrose oleate, polyoxyethylene lauryl ethers, polyoxyethylene derivatives of sorbitol esters, polyoxyethylene (20) sorbitan monolaurate, polyoxyethylene (20) sorbitan monooleate, polyoxyethylene (20) sorbitan monopalmitate, polyoxyethylene (20) sorbitan monostearate, polyoxyethylene (20) sorbitan monotristearate, POE 1.5 nonylphenyl, POE 4 nonylphenyl ether, POE 6 nonylphenyl ether, POE 7.5 nonylphenyl ether, POE 9 nonylphenyl ether 13.0 616, POE 12 nonylphenyl ether, 7 dinonylphenyl ether, POE 10 stearyl ether, POE 20 stearyl ether, POE 100 stearyl ether, POE 2 oleyl ether and polyvinylalcohols (PVA). More than one water-soluble surfactant may be employed.

Typically, minor amounts of water-soluble surfactant are blended with the aqueous solution or aqueous dispersion. The concentration of water-soluble surfactant in the resulting blend of the water-soluble surfactant and the aqueous solution or aqueous dispersion maybe in the range of from 0.1 to 6 percent by weight, preferably 0.2 to 2 percent by weight.

The third step is to form the primary oil phase by dissolving the polymer in a volatile organic solvent. Preferably, the volatile organic solvent has a boiling point of less than 80° C., more preferably less than 60° C., most preferably less than 50° C., for example less than 40° C. Preferably, the volatile organic solvent is selected from the group consisting of alcohols, (for example, methanol or ethanol), acetone, ethers (for example, diethyl ether), ketones (methyl isobutyl ketone or methyl ethyl ketone) halogenated hydrocarbons (for example, dichloromethane, dichoroethane, trichlorethane, and chloroform), ethyl acetate, alkyl sulfoxides such as dimethyl sulfoxide (DMSO), dimethylamine, dimethyl formamide (DMF), N-methyl-2-pyrolidone and mixtures thereof. Where the volatile organic solvent is water-extractable, for example is selected from an alcohol, ethyl acetate, DMF or DMSO, a portion of the volatile organic solvent may be extracted into the aqueous phase thereby lowering the interfacial tension between the aqueous phase and primary oil phase. As discussed above, this may assist in reducing the size of the droplets of internal aqueous phase thereby resulting in a reduction in the size of the microparticles.

The primary oil phase may comprise a volatile organic solvent which is miscible with the secondary oil phase and/or a volatile organic solvent which is immiscible with the secondary oil phase or has a low solubility therein. Preferably, the primary oil phase comprises a blend of a volatile organic solvent which is miscible with the secondary oil phase and a volatile organic solvent which is immiscible with the secondary oil phase or has a low solubility therein. Without wishing to be bound by any theory it is believed that extraction of the miscible volatile organic solvent into the secondary oil phase assists in the formation of the microparticles.

Where the primary oil phase consists solely of a volatile organic solvent which is immiscible with the secondary oil phase or has a low solubility therein, a solubilising agent may be added to the primary oil phase during preparation of the water in primary oil emulsion. Alternatively, the solubilising agent may be added to the intermediate water in primary oil in secondary oil double emulsion. Without wising to be bound by any theory, the solubilising agent extracts at least part of the primary oil phase into the secondary oil phase thereby assisting in the formation of the microcapsules.

The size of the microparticles increases with increasing concentration of polymer in the primary oil phase. Suitably, the polymer is dissolved in the primary oil phase in an amount in the range 1% to 50% by weight, preferably 2% to 15% by weight.

It is to be appreciated that the polymer may be dissolved in the primary oil phase either prior to or simultaneously with preparing the blend of the water-soluble surfactant and the aqueous solution or aqueous dispersion.

The fourth step is to form the water in primary oil emulsion, which is preferably accomplished by slowly pouring the solution of the polymer in the primary oil phase into the blend of the aqueous solution or aqueous dispersion of the oil or gas field production chemical and the water-soluble surfactant while intensive blending is applied to the resulting mixture. The blending operation for the emulsion should be designed to minimize the size of the internal aqueous phase, for example, stirring rates and times should be designed to form small aqueous phase droplets having mean diameters of from about 100 nm to about 1 micron, preferably 100 to 750 nm, more preferably 100 to 500 nm, most preferably 200 to 300 nm. Preferably, the mixture should be vigorously stirred for about 5 to 20 minutes. Preferably, the mixture is stirred under high shear conditions. Suitably, the shear rate is at least 0.5 ms⁻¹, preferably, at least 1 ms⁻¹, more preferably, at least 5 ms⁻¹, for example, at least 10 ms⁻¹. Mechanical mixing equipment or blenders may be used to impart the desired shear rate to the mixture. Suitably, the water in primary oil emulsion may be prepared using a high shear mechanical mixing device, for example, an Ultraturrax™, Silverson™ or Couette™ mixer.

Preferably, the internal aqueous phase of the water in primary oil emulsion formed in step (a) should amount to from 10 to 70 percent, more preferably from 30 to 60 percent of the total volume of the emulsion.

Density control of the water in primary oil emulsion may be used to enhance the stability of the emulsion. This may be accomplished by addition of weighting agents to the internal aqueous phase of the water in primary oil emulsion. For example, minor amounts of soluble salts such as sodium or potassium chloride may be added to the internal aqueous phase. Suitably, the aqueous phase may comprise from 0.5 to 20 percent by weight of soluble salts.

The intermediate water in primary oil in secondary oil double emulsion may be made in a basic two step approach.

The first step is to blend the secondary oil phase with an oil-soluble surfactant. Preferably, the oil-soluble surfactant has a hydrophilic/lipophilic balance (HLB) suited to the other liquids present in the emulsion. Preferably, the oil-soluble surfactant has an HLB value of less than 8, preferably less than 6, more preferably in the range 4 to 6. Examples of suitable surfactants include sorbitan monooleate, sorbitan monostearate, sorbitan trioleate, sorbitan monopalmitate, sorbitan tristearate, non-ionic block copolymers, polyoxyethylene stearyl alcohols, polyoxyethylene cocoa amines, fatty amine ethoxylates, polyoxyethylene oleyl alcohols, polyoxyethylene stearyl alcohols, polyoxyethylene cetyl alcohols, fatty acid polyglycol esters, glyceryl stearate, glyceryl oleate, propylene glycol stearate, polyoxyethylene oleates, polyoxyethylene stearates, diethylene glycol stearate and fatty acid polyamine condensates. More than one oil-soluble surfactant may be employed.

A preferred surfactant is sorbitan monooleate (for example SPAN 80™). Also preferred are surfactants sold under the trademark “Hypermer” produced by Imperial Chemical Industries (for example, Hypermer LP6 and Hypermer B246). These surfactants are described in U.S. Pat. No. 4,504,276, U.S. Pat. No. 4,509,950 and U.S. Pat. No. 4,776,966 (which are herein incorporated by reference).

The surfactants sold under the trademark “Hypermer” are described as block or graft co-polymers of the general formula (A-COO)ₘB, where m in an integer of at least 2 and, A is a polymeric component having a molecular weight of at least 500 and is the residue of an oil-soluble complex mono-carboxylic acid of the general structural formula:
R—CO—[O—CHR₁—(R₂)ₙ—CO]ₚ—O—CHR₁—(R₂)ₙ—COOH
in which R is hydrogen or a monovalent hydrocarbon or substituted hydrocarbon group, R₁ is hydrogen or a monovalent C₁ to C₂₄ hydrocarbon group, R₂ is a divalent C₁ to C₂₄ hydrocarbon group, n is zero or 1 and p is zero or an integer of up to 200; and (b) B is a polymeric component having a molecular weight of at least 500 and, in the case where m is 2, is the divalent residue of a water-soluble polyalkylene glycol of the general formula:
H—[O—CHR₃—CH₂]_{q}—O—CHR₃—CH₂OH
in which R₃ is hydrogen or a C₁ to C₃ allyl group, q is an integer from 10 to 500, or, in the case where m is greater than 2, is the residue of valency m of a water-soluble polyether polyol of the general formula:
R₄{[O—CHR₃—CH₂]ᵣ—OH}ₘ
in which R₃ and m have their previous significance, r is zero or an integer from 1 to 500, provided that the total number of:
—O—CHR₃—CH₂—
units in the molecule is at least 10, and R₄ is the residue of an organic compound containing in the molecule m hydrogen atoms reactive with an alkylene oxide.

Additional “Hypermer” surfactants include the reaction product of a polyalk(en)yl succinic anhydride with a polar compound containing in the molecule at least one hydroxyl or amino group. The preferred polyalk(en)yl succinic anhydride are poly(isobutenyl)succinic anhydrides having a molecular weight in the range of 400 to 5000. The preferred polar compound with which the anhydride is reacted may be a polyol such as ethylene glycol, propylene glycol, glycerol, trimethylol propane, pentaerythritol or sorbital; or with a polyamine, for example ethylene diamine, trimethylene diamine, hexamethylene diamine, dimethylaminopropylamine or diethylaminopropylamine or with a hydroxyamine for example monoethanolamine, diethanolamine, dipropanolamine, tris(hydroxymethyl)aminomethane or dimethylaminoethanol.

Preferably, the degradable polymer is insoluble or at most sparingly soluble in the secondary oil phase. The secondary oil phase may be an alkane having from 10 to 16 carbon atoms, preferably 10 to 14 carbon atoms, for example, decane or dodecane. Preferably, the secondary oil phase is a vegetable oil or a synthetic oil. Suitably, the vegetable oil comprises a triglyceride formed by esterification of glycerol with a fatty acid having from 10 to 30 carbon atoms. Suitably, the triglyceride is formed by esterification of glycerol with saturated fatty acids, for example palmitic acid or stearic acid and/or unsaturated fatty acids, for example, oleic acid, linoleic acid and linolenic acid. Preferably, the vegetable oil is corn oil, sunflower oil, rape seed oil or soya oil. Preferably, the synthetic oil is a silicone oil, for example, a poly(dimethyl)siloxane, or a fluorocarbon oil, for example, a linear, branched, cyclic, saturated or unsaturated fluorinated hydrocarbon oil. Typically, the fluorinated hydrocarbon has at least 30% of its hydrogen atoms replaced by fluorine atoms. It is also envisaged that the fluorinated hydrocarbon may have a portion of its hydrogen atoms replaced by bromine and/or chlorine atoms. Optionally, the fluorinated hydrocarbon may contain at least one heteroatom. Particularly preferred synthetic oils include perfluorocarbon oils.

Typically, minor amounts of oil-soluble surfactant are blended with the secondary oil phase. The concentration of oil-soluble surfactant in the blend of oil-soluble surfactant and secondary oil phase may be in the range of from 0.1 to 6 percent by weight, preferably 0.2 to 2 percent by weight.

The intermediate water in primary oil in secondary oil double emulsion may be formed by slowly pouring the water in primary oil emulsion into the blend of the secondary oil phase and oil-soluble surfactant with stirring of the resulting mixture. Preferably, the resulting mixture is stirred under high shear conditions. Suitable high shear conditions are as described above for the preparation of the water in primary oil emulsion. Preferably, formation of the intermediate water in primary oil in secondary oil double emulsion is aided by subjecting the stirred mixture of the water in primary oil emulsion and the blend of oil-soluble surfactant and secondary oil phase to sonication, preferably ultrasonication. Without wishing to be bound by any theory, sonication of the mixture aids formation of the water in primary oil in secondary oil double emulsion by reducing the size of the droplets of water in primary oil emulsion dispersed in the secondary oil phase.

Preferably, the ratio of the volume of the water in primary oil emulsion to the volume of the secondary oil phase is 0.1 to 0.5, most preferably 0.15 to 0.3.

Preferably, the volatile organic solvent is allowed to evaporate by stirring the intermediate water in primary oil in secondary oil double emulsion at a temperature of at least 18° C., preferably at a temperature of least 30° C. Preferably, the stirred intermediate water in primary oil in secondary oil double emulsion is heated to a temperature which is at least 2.5° C., more preferably at least 10° C. below the boiling point of the volatile organic solvent. Preferably, the volatile solvent is allowed to evaporate by stirring the intermediate water in primary oil in secondary oil double emulsion under high shear conditions. Preferably, the stirred intermediate water in primary oil in secondary oil double emulsion is subjected to sonication, preferably ultrasonication. Preferably, the intermediate water in primary oil in secondary oil double emulsion is stirred at a reduced pressure thereby aiding evaporation of the volatile solvent.

Where a vegetable oil, for example, corn oil is used as the secondary oil phase, the primary oil phase preferably comprises a solution of the polymer in a volatile organic solvent which is miscible with the secondary oil phase (for example, dichloromethane) and a volatile organic solvent which is either immiscible or has a low solubility in the secondary oil phase (for example, ethanol). The miscible volatile organic solvent diffuses out into the secondary oil phase as soon as the water in primary oil emulsion is mixed with the secondary oil phase thereby aiding the solidification of the polymer around the droplets of the internal aqueous phase. Preferably, the volume ratio of immiscible/low solubility solvent to miscible solvent in the primary oil phase is in the range 1:1 to 5:1.

Where a silicone oil is used as the secondary oil phase, the primary oil phase preferably comprises a solution of the polymer in dichloromethane. After mixing the water in primary oil emulsion with the silicone oil, a solubilising agent, for example, petroleum ether or methyl ethyl ketone may be added and the mixture stirred, preferably under high shear conditions, so that at least part of the primary oil phase is extracted into the secondary oil phase. Preferably, the ratio of the volume of the solubilising agent to the volume of the primary oil phase is 0.05 to 0.5.

Suitably, the microparticles may be collected by filtration (for example, cross-flow filtration or gel filtration), centrifugation, dialysis, evaporation of the dispersing medium (for example by spraying the suspension onto a spinning heated disc), spray drying, or freeze drying. Preferably, the separated microparticles are washed with an organic solvent, for example, hexane, heptane, octane, depolarised kerosene, and petroleum ether. The microparticles may be dried, for example, in an oven, by hot air blowing, by freeze drying, or by spray drying. In order to mitigate the risk of agglomeration of the microparticles, it is preferred to separate and dry the microparticles in the presence of a dispersant. Suitable dispersants include polyacrylic acids; polymaleic acids; polyacrylamides; polymethacrylates; polyvinylsulphonates; copolymers of monomers selected from the group consisting of acrylic acid, maleic acid, acrylamide, methacrylate, 2-acrylamido-2-methylpropane-sulfonic acid, and vinylsulphonate; lignosulphonates; hydroxy methyl cellulose; carboxy methyl cellulose; carboxy methyl ethyl cellulose; hydroxy methyl ethyl cellulose; hydroxyl propyl methyl cellulose; methyl hydroxy propyl cellulose; sodium alginates; polyvinyl pyrolidone; polyvinyl pyrolidone acrylic acid co-polymers; polyvinyl pyrolidone caprolactam co-polymers; polyvinyl alcohol; polyphosphates, polystyrene-maleinates, PEO homopolymers, perethoxylated caster oils, poloxamers and poloxamines. Poloxamers are linear ABA block co-polymers having the general structural formula (EO)ₙ-(PO)ₘ-(EO)ₙ where n and m are integers and EO and PO represent units derived from ethylene oxide and propylene oxide respectively. Polaxamines are ABA block co-polymers having a branched structure with a central ethylene diamine bridge and have the general formula [(EO)ₙ-(PO)ₘ]₂-N—CH₂—CH₂—N-[(EO)ₙ-(PO)ₘ]₂), where n, m, EO and PO are as defined for poloxamers. Other suitable dispersants include surfactants having hydrophile/lipophile balances greater than 10, for example, polyoxyethylene (20) sorbitan monolaurate, polyoxyethylene (20) sorbitan monooleate, polyoxyethylene (20) sorbitan monopalmitate, polyoxyethylene (20) sorbitan monostearate, polyoxyethylene (20) sorbitan monotristearate, POE 10 stearyl ether, POE 20 stearyl ether, POE 100 stearyl ether, POE 2 oleyl ether, POE 24 lauryl ether, sodium bis-2-ethylhexylsulfosuccinate, sodium dodecyl sulfate, sodium laureth sulfate, cetyltrimethylammonium bromide, didoceylammonium bromide, and myristyltrimethylammonium bromide. Suitably, the dried microparticles may be resuspended in either an aqueous or organic medium prior to injection downhole into a hydrocarbon-bearing formation. Suitable, aqueous and organic media include those disclosed above.

According to a second preferred embodiment of the present invention there is provided a method for preparing microparticles comprising an aqueous phase comprising an aqueous solution of a water-soluble oil or gas field production chemical or an aqueous dispersion of a water-dispersible oil or gas field production chemical encapsulated in a continuous polymeric phase comprising a degradable polymer, which method comprises:

a) mixing a primary aqueous phase comprising an aqueous solution of an water-soluble oil or gas field production chemical or an aqueous dispersion of a water-dispersible oil or gas field production chemical with an oil phase comprising a solution of a polymer in a volatile organic solvent in the presence of a first water-soluble surfactant to form a water in oil emulsion having the primary aqueous phase dispersed in the oil phase in the form of droplets having a mean diameter of less than 10 microns, preferably less than 5 microns, more preferably less than 1 micron;

b) mixing the water in oil emulsion with a secondary aqueous phase in the presence of a second water-soluble surfactant to form a water in oil in water double emulsion; and

c) at least in part evaporating the volatile organic solvent from the water in oil in water double emulsion such that the polymer accumulates around the droplets of the primary aqueous phase and hardens to form microparticles comprising a continuous polymeric phase encapsulating the aqueous phase having a mean particle diameter of less than 10 microns, preferably less than 5 microns, more preferably less than 1 micron.

Without wishing to be bound by any theory, the intermediate water in oil in water double emulsion comprises discrete droplets of the water in oil emulsion dispersed in the secondary aqueous phase. Where it is desired to form microcapsules, each discrete dispersed droplet of the water in oil emulsion preferably contains a single droplet of the internal aqueous phase. Upon evaporation of the volatile solvent, the polymer accumulates around the single droplet of the internal aqueous phase to form a hardened polymeric wall encapsulating the droplet of aqueous phase. Where it is desired to form microspheres, each discrete dispersed droplet of the water in primary oil emulsion preferably contains a plurality of droplets of the internal aqueous phase. Upon evaporation of the volatile solvent, the polymer accumulates around the plurality of droplets of the internal aqueous phase forming a hardened polymeric matrix encapsulating said droplets. Suitably, the dispersed droplets of the water in primary oil emulsion have a mean diameter of less than 50 microns, preferably, less than 25 microns, more preferably less than 10 microns, most preferably less than 5 microns, for example, less than 2 microns.

The intermediate water in oil emulsion may be made in a basic four step approach, as described above for the first preferred embodiment of the present invention.

Preferably, the oil phase comprises a volatile organic solvent which is immiscible with the secondary aqueous phase or has a low solubility therein and a volatile organic solvent which is miscible with the secondary aqueous phase such that at least part of the oil phase is extracted into the secondary aqueous phase and also into the primary aqueous phase. Examples of volatile organic solvents which are immiscible with the secondary aqueous phase include dichloromethane, dichloroethane, trichloroethane, and chloroform. Examples of volatile organic solvents which are miscible with the primary and secondary aqueous phases include alcohols, acetone, DMF and DMSO, dimethyl ether, dimethyl amine, methyl isobutyl ketone, methylethyl ketone, and N-methyl-2-pyrolidone. Suitably, the volume ratio of “water-immiscible solvent” to extractable solvent in the oil phase is in the range 1:1 to 5:1.

Where the oil phase consists of a volatile solvent which is immiscible with the secondary aqueous phase, a solubilising agent may be added to the intermediate water in oil in water double emulsion. The solubilising agent at least in part extracts the oil phase into the secondary aqueous phase thereby assisting in the formation of the microparticles. Suitable solubilising agents include ethanol, methanol, acetone, methyl isobutyl ketone, and methylethyl ketone.

Examples of suitable first water-soluble surfactants include those water-soluble surfactants described above in relation to the first preferred embodiment of the present invention. More than one first water-soluble surfactant may be employed.

The intermediate water in oil in water double emulsion may be made in a basic two step approach.

The first step is to blend the secondary aqueous phase with the second water-soluble surfactant The second water-soluble surfactant may be selected from those water-soluble surfactants listed above in relation to the first preferred embodiment of the present invention. The second water-soluble surfactant may be the same or different to the first water-soluble surfactant. More than one second water-soluble surfactant may be employed.

Preferably, the secondary aqueous phase is pure water, tap water, deionised water, seawater, sulphate reduced seawater or a synthetic brine.

Typically, minor amounts of the second water-soluble surfactant are blended with the secondary aqueous phase. The concentration of second water-soluble surfactant in the blend of second water-soluble surfactant and secondary aqueous phase may be in the range of from 0.1 to 6 percent by weight, preferably 0.2 to 2 percent by weight.

The second step may be carried out by slowly pouring the intermediate water in oil emulsion into the blend of the secondary aqueous phase and second water-soluble surfactant with stirring of the resulting mixture. Preferably, the resulting mixture is stirred under high shear conditions. Suitable high shear conditions are as described above. Preferably, formation of the intermediate water in oil in water double emulsion is aided by subjecting the stirred mixture of the water in oil emulsion and the blend of second water-soluble surfactant and secondary aqueous phase to sonication, preferably ultrasonication. Without wishing to be bound by any theory, sonication of the mixture aids formation of the water in oil in water double emulsion by reducing the size of the droplets of water in oil emulsion dispersed in the secondary aqueous phase.

Preferably, the ratio of the volume of the water in oil emulsion to the volume of the secondary aqueous phase is 0.01 to 0.1, most preferably 0.02 to 0.07.

Preferably, the volatile solvent is allowed to evaporate by stirring the intermediate water in oil in water double emulsion at a temperature of at least 18° C., preferably at least 30° C. Preferably, the intermediate water in oil in water double emulsion is stirred at temperature which is at least 2.5° C. below, preferably at least 10° C. below the boiling point of the volatile organic solvent. Preferably, the intermediate water in oil in water double emulsion is stirred under high shear conditions. Preferably, the stirred intermediate water in oil in water double emulsion is subjected to sonication, preferably ultrasonication. Preferably, the intermediate water in oil in water double emulsion is stirred at reduced pressure.

The microparticles may be collected as described above. Suitably, the separated microparticles are washed with water. Preferably, the separated microparticles are dried, as described above. In order to mitigate the risk of agglomeration of the microparticles, it is preferred to separate and dry the microparticles in the presence of a dispersant as described above. Suitably, the dried microparticles may be suspended in a liquid medium as described above.

Suitably, the oil or gas field production chemical that is dissolved or dispersed in the encapsulated aqueous phase of the microparticles may be selected from the group consisting of water-soluble or water-dispersible (i) scale inhibitors, (ii) corrosion inhibitors, (iii) hydrogen sulphide scavengers or (iv) hydrate inhibitors.

Scale inhibitors include water-soluble organic molecules having at least 2 carboxylic and/or phosphonic acid and/or sulphonic acid groups e.g. 2-30 such groups. Preferred scale inhibitors are oligomers or polymers, or may be monomers with at least one hydroxyl group and/or amino nitrogen atom, especially in hydroxycarboxylic acids or hydroxy or aminophosphonic, or, sulphonic acids. Scale inhibitors are used primarily for inhibiting calcium and/or barium scale. Examples of such compounds used as scale inhibitors are aliphatic phosphonic acids having 2-50 carbons, such as hydroxyethyl diphosphonic acid, and aminoalkyl phosphonic acids, e.g. polyaminomethylene phosphonates with 2-10 N atoms e.g. each bearing at least one methylene phosphonic acid group; examples of the latter are ethylenediamine tetra(methylene phosphonate), diethylenetriamine penta(methylene phosphonate) and the triamine- and tetramine-polymethylene phosphonates with 2-4 methylene groups between each N atom, at least 2 of the numbers of methylene groups in each phosphonate being different (e.g. as described further in published EP-A479462, the disclosure of which is herein incorporated by reference). Other scale inhibitors are polycarboxylic acids such as acrylic, maleic, lactic or tartaric acids, and polymeric anionic compounds such as polyvinyl sulphonic acid and poly(meth)acrylic acids, optionally with at least some phosphonyl or phosphinyl groups as in phosphinyl polyacrylates. The scale inhibitors are suitably at least partly in the form of their alkali metal salts e.g. sodium salts.

Examples of corrosion inhibitors are compounds for inhibiting corrosion on steel, especially under anaerobic conditions, and may especially be film formers capable of being deposited as a film on a metal surface e.g. a steel surface such as a pipeline wall. Such compounds may be non-quaternised long aliphatic chain hydrocarbyl N-heterocyclic compounds; mono- or di-ethylenically unsaturated aliphatic groups e.g. of 8-24 carbons such as oleyl are preferred. The N-heterocyclic group can have 1-3 ring nitrogen atoms with 5-7 ring atoms in each ring, imidazole and imidazoline rings are preferred. The ring may also have an aminoalkyl e.g. 2-aminoethyl or hydroxyalkyl e.g. 2-hydroxyethyl substituent. Oleyl imidazoline may be used.

Hydrogen sulphide scavengers include oxidants, such as inorganic peroxides, e.g. sodium peroxide, or chlorine dioxide, or aldehydes e.g. of 1-10 carbons such as formaldehyde or glutaraldehyde or (meth)acrolein.

Hydrate inhibitors include salts of the formula [R¹(R²)XR³]^{+Y-}, wherein each of R¹, R² and R³ is bonded directly to X, each of R¹ and R², which may the same or different is an alkyl group of at least 4 carbons, X is S, NR⁴ or PR⁴, wherein each of R³ and R⁴, which may be the same or different, represents hydrogen or an organic group with the proviso that at least one of R³ and R⁴ is an organic group of at least 4 carbons and Y is an anion. These salts may be used in combination with a corrosion inhibitor and optionally a water soluble polymer of a polar ethylenically unsaturated compound. Preferably, the polymer is a homopolymer or a copolymer of an ethylenically unsaturated N-heterocyclic carbonyl compound, for example, a homopolymer or copolymer of N-vinyl-omega caprolactam. Such hydrate inhibitors are disclosed in EP 0770169 and WO 96/29501 which are herein incorporated by reference.

Preferably, the oil or gas field production chemical may be dissolved or dispersed in the encapsulated aqueous solution or aqueous dispersion respectively in an amount in the range of from 1 to 50 percent by weight, preferably 5 to 30 percent by weight.

When the microparticles are placed in a subterranean hydrocarbon-bearing formation or in a production well bore, release of the aqueous solution or aqueous dispersion from the microparticles into the formation or production well is effected by in situ degradation of the polymer which encapsulates the aqueous solution or aqueous dispersion. Where the microparticles are microcapsules, in situ degradation of the polymer forming the wall of the microcapsules may result in either rupturing of the microcapsule wall or increased permeability of the oil or gas field production chemical through the microcapsule wall. Where the microparticles are microspheres, in situ degradation of the polymer forming the polymeric matrix may result in increased permeability of the polymeric matrix to the oil or gas field production chemical.

In accordance with the present invention, the microparticles may be formulated to possess varying rates of in situ degradation. Microparticle degradation is dependent on at least three parameters: the chemical composition of the polymer encapsulating the aqueous solution or aqueous dispersion, the physical dimensions of the microparticles and the microparticle environment.

Where the microparticles are microcapsules, parameters relating to physical dimensions of the microcapsules include microcapsule size and wall thickness. Downhole environmental parameters include the formation temperature and pressure, solubility of the polymer forming the microcapsule wall in the formation fluids and the partial pressure differential between the inside and outside of the microcapsule wall.

Where the microparticles are microspheres, parameters relating to physical dimensions of the microspheres include the microsphere size and the porosity of the continuous polymeric matrix. Downhole environmental parameters include formation temperature and pressure and solubility of the polymer forming the continuous polymeric matrix in the formation fluids.

When formulating microparticles to degrade in situ, a polymer may be chosen to encapsulate the aqueous solution or aqueous dispersion which is either sparingly soluble in the formation fluids or is soluble in the formation fluids above a threshold temperature. For microcapsules, the release time for the oil or gas field production chemical is therefore dependent on the microcapsule wall thickness and the rate of dissolution of the polymeric wall material under downhole conditions. For microspheres, the release time for the oil or gas field production chemical is dependent on the size of the microspheres, any increase in porosity of the microspheres upon dissolution of the polymeric matrix material and the rate of dissolution of the polymeric matrix material under downhole conditions. The release time is the interval from when the microparticles first enter the formation until the microparticles degrade to release substantially all of the aqueous solution or aqueous dispersion.

Microparticles may also be formulated with a release time independent of the solubility of the encapsulating polymer. Thus, the polymeric material chosen to form the wall of the microcapsules or the polymeric matrix of the microspheres may be thermally degradable and/or biodegradable. Suitably, the polymeric material may be a nutrient for microorganisms which are either indigenous or exogenous to the hydrocarbon-bearing formation. Where the microparticles are microcapsules, the wall thickness may be such that thermal degradation and/or bidegradation of the polymeric material chosen to form the microcapsule wall results in rupturing of the microcapsule wall above a threshold temperature and pressure, for example, at the formation temperature and pressure or at the temperature and pressure encountered down hole in a production well. Where the microparticles are microspheres, the polymeric material chosen to form the polymeric matrix may be such that thermal degradation and/or biodegradation of the polymer above a threshold temperature, results in increased porosity of the polymeric matrix thereby leading to an increase in the rate of diffusion of the oil or gas field production chemical out of the microsphere into the formation fluids.

Suitable degradable polymers include hydrophobic polymers such a polytriflorochloroethylene which degrades due to its relative solubility in the formation fluids, yet is relatively insoluble in the encapsulated aqueous solution or aqueous dispersion of the oil or gas field production chemical.

Certain polymers such as polyalkacrylates exhibit hydrophilic characteristics at relatively low molecular weight and hydrophobic properties at relatively high molecular weight. The high molecular weight polymers are preferably selected as the degradable polymer, because they are relatively insoluble in aqueous formation fluids or in the encapsulated aqueous solution or aqueous dispersion of the oil or gas field production chemical but are relatively soluble in hydrocarbon formation fluids. Examples of suitable polyalkacrylates include the homopolymers of methacrylate and ethylacrylate, the copolymers of methacrylate and ethylacrylate, and the copolymers of methacrylate, methyl methacrylate, and/or ethylacrylate with quaternised acrylates, for example, acrylates with quaternary ammonium groups. Preferably, the polyalkacrylate has a molecular weight of 100,000 to 800,000, more preferably 130,000 to 180,000. Preferably, the polyacrylate is a copolymer of methacrylate, ethylacrylate and quaternised acrylate having a mole ratio of ethylacrylate:methyl methacrylate:quaternised acrylate units of 1-3:1-3:0.1-0.3.

Suitable degradable polymers include polyalkyl cyanoacrylates, for example, homopolymers and copolymers of monomers having the general formula CH₂═C(CN)CO₂R where R represents a C₁ to C₅ alkyl group, preferably methyl, ethyl or butyl. Preferably the polyalkyl cyanoacrylate has a molecular weight of 5,000 to 200,000, more preferably 10,000 to 100,000.

Further degradable polymers include aliphatic polyesters. Suitable aliphatic polyesters include homopolymers and copolymers of monomers selected from the group consisting of glycolic acid, lactic acid, ε-caprolactone, para-dioxanone, hydroxybutyrate and β-malic acid, in particular, poly(glycolic acid), poly(lactic acid), and copolymers of lactic acid and glycolic acid. Preferably, the aliphatic polyester has a molecular weight of 1,500 to 200,000, more preferably 5,000 to 100,000, most preferably 9,000 to 80,000. Preferably, the polyester co-polymers comprise units derived from two different monomers where the mole ratio of the first monomeric unit to the second monomeric unit is 0.1-0.9:0.9-0.1.

In a third embodiment of the present invention there is provided a suspension comprising microparticles suspended in a liquid medium wherein the microparticles are prepared as described above.

Suitably, the microparticles which are suspended in the liquid medium have a mean diameter of less than 10 microns, preferably less than 5 microns, more preferably less than 1 micron. Typically, the microparticles have a mean diameter in the range 100-750 nm, for example, 200-500 nm or 200-300 nm. Preferably, the suspended microparticles have a monodispersed size distribution. An advantage of the suspension of the present invention is that the small size of the microparticles allows the microparticles to enter and percolate through a hydrocarbon-bearing subterranean formation.

The liquid medium may be an oil, an organic solvent or water, preferably water. Where the liquid medium is an oil, the oil may be kerosene, diesel, biodiesel, base oil or crude oil. Where the liquid medium is an organic solvent, the organic solvent may be water-dispersible, for example, a mutual solvent such as methyl butyl ether (MBE), butyl monoglycol ether (BGE) or a biodegradable ester solvent such as Arrivasol™. Where the liquid medium is water, the water may be fresh water, river water, aquifer water or sea water.

Suitably, the microparticles are dispersed in the liquid medium in an amount of from 20 to 50, preferably 30 to 50% by weight.

In yet a further embodiment of the process of the present invention there is provided a method of introducing an oil or gas field production chemical into a subterranean formation comprising:

(a) injecting a suspension comprising microparticles suspended in a liquid medium into a formation through an injection well wherein the microparticles comprise an aqueous phase comprising an aqueous solution of a water-soluble oil or gas field production chemical or an aqueous dispersion of a water-dispersible oil or gas field production chemical encapsulated in a continuous polymeric phase wherein the microparticles have a mean diameter of less than 10 microns, preferably less than 5 microns, more preferably less than 1 micron, and the polymer forming the continuous polymer phase is degradable under the conditions encountered in the formation;

(b) allowing the suspension to percolate through the formation towards a production well; and

(c) controllably releasing the aqueous solution of the water-soluble oil or gas field production chemical or the aqueous dispersion of the water-dispersible oil or gas field production chemical from the microparticles into the formation and/or the production well through degradation of the polymer forming the continuous polymeric phase.

Preferably, the microparticles may be microcapsules or microspheres prepared as described above. However, it is envisaged that other delayed release microparticles, having a mean particle diameter of less than 10 microns, preferably less than 5 microns, more preferably less than 1 micron; may be used.

Where the oil or gas field production chemical is a scale inhibitor, corrosion inhibitor or a gas hydrate inhibitor, the production chemical is preferably released in the near well bore region of the production well. By “near well bore region of the production well” is meant a radial distance of less than 100 feet, preferably less than 50 feet, more preferably, less than 30 feet from the well bore of the production well.

The rate of degradation of the polymer forming the polymeric phase (i.e. the wall of a microcapsule or the polymeric matrix of a microsphere) will be dependent upon, amongst other parameters, the temperature, pressure, and the formation fluids which the microparticles encounter in the formation. Typically, the suspension is injected down the injection well at a temperature of less than 10° C., for example 3 to 5° C. Typically, the temperature of the subterranean formation in the near well bore region of the producing well is in the range 75-150° C. The temperature of the injected suspension will therefore increase as it percolates through the formation. The increase in temperature of the injected suspension with increasing radial distance from the injection well can be accurately determined (as would be well known to the man skilled in the art). The polymer which forms the polymeric phase (i.e. the microcapsule wall or the microsphere polymeric matrix) and the physical dimensions of the microparticles can be chosen such that that the microparticles release substantially all of the aqueous solution or aqueous dispersion of the oil or gas field chemical (through degradation of the polymer forming the microcapsule wall or microsphere matrix) in the near well bore region of the production well. Suitably, the microparticles start to release the aqueous solution or aqueous dispersion of the oil or gas field production chemical at a threshold temperature in the range 50 to 150° C., preferably 50 to 100° C.

Where the oil or gas field production chemical is a hydrogen sulphide scavenger, the polymer of the polymeric phase and the physical dimensions of the microparticles may be chosen such that the microparticles begin to release the hydrogen sulphide scavenger as the microparticles percolate through the formation from the injection well towards the production well.

Suitably, the suspension comprises microparticles containing the aqueous solution or aqueous dispersion of the oil or gas field production chemical suspended in injection water (e.g. river water, aquifer water or seawater). The microparticles readily enter the porous formation and are capable of traveling through the formation together with the injection water.

Suitably, the suspension propagates through the formation at a rate of 15 to 100 feet per day. Typically, the temperature of the injected suspension increases at a rate of 1 to 10° C. per 100 feet in the radial direction from the injection well towards the production well. Suitably, the injection well is 0.25 to 1 mile from the production well.

Typically, the suspension of microparticles is dosed into the injection water. The suspension may be continuously dosed into the injection water in which case the amount of oil or gas field production chemical contained in the microparticles is selected so that release of the oil or gas field production chemical into the formation and/or the production well gives an effective concentration of oil or gas field production chemical. Where the oil or gas field production chemical is a water-soluble scale inhibitor, the concentration of the aqueous solution of scale inhibitor contained in the microparticles is preferably 2.5 to 50% w/v, more preferably 5 to 40% w/v and most preferably 10 to 30% w/v.

The suspension of microparticles may be intermittently dosed into the injection water in which case the amount of oil or gas field production chemical contained in the microparticles may be higher. For example, where the oil or gas field production chemical is a water-soluble scale inhibitor, the concentration of scale inhibitor in the aqueous solution is preferably, 5 to 40% w/v, more preferably 10 to 40% w/v. Here the scale inhibitor is released from the microparticles into the formation, preferably in the near well bore region and at least, in part, adsorbs onto the surfaces of the porous rock formation. During intervals when the suspension of microparticles is not being dosed into the injection water, the scale inhibitor leaches from the surfaces of the rock thereby maintaining an effective concentration of scale inhibitor for scale control.

Preferably, the amount of scale inhibitor released into the production water is in the range 1 to 200 ppm.

It is also envisaged that a suspension of microparticles, prepared as described in the first and second embodiments of the present invention, may be injected into a formation under pressure via a production well. The production well is then preferably shut-in for 2-50 hours, for example, 5-15 hours during which time the suspension of microparticles percolates into the formation and the microparticles are believed to become trapped in the formation matrix. The polymeric phase of the microparticles degrades under the conditions encountered in the near well bore region of the production well thereby releasing the aqueous solution of the oil or gas field production chemical or the aqueous dispersion of the oil or gas field production chemical into the fluids present in the formation. After shut-in, the well is returned to production. The produced fluids may be analysed, for example, at the surface to monitor the concentration of oil or gas field production chemical therein. Suitably, the suspension comprises microparticles, prepared as described in the first or second embodiments of the present invention, suspended in an aqueous or oil medium. Where the formation is oil-bearing, the shut-in process involving the introduction of the suspension of the microparticles in the liquid medium may be optionally preceded by a pre-flush of the oil-bearing rock formation using an oil such as diesel, biodiesel, kerosene, base oil or crude oil. Introduction of the suspension of microparticles in the liquid medium may be followed by a subsequent separate step of over-flushing the production well with an oil. The oil used for the over-flush may be diesel, biodiesel, kerosene, base oil or oil produced by the well being treated. The amount of oil used for over-flushing the production well is suitably such that it reaches and flushes a target zone which is up to about 20 feet in a radial direction from the well bore. Suitably, the amount of oil used for the over-flush is in the range from 30 to 4000 bbls. Where the oil used for the over-flush is oil produced by the well being treated, the over-flush may be carried out in an inverse way e.g. as a back-sweep i.e. by making the crude oil as it emerges to the surface from the production well perform the function of the over-flush oil. After this period the oil production can be re-started. Such “squeeze” methods can be used to achieve scale inhibition, and hydrogen sulphide scavenging, while for corrosion and gas hydrate inhibition, the suspension is usually injected continuously downhole. For corrosion inhibition, or hydrogen sulphide scavenging, the suspension may, if desired, be injected into the well without the overflush.

In yet a further embodiment of the present invention there is provided a microcapsule comprising a well-defined core of an aqueous solution of a water-soluble oil or gas field production chemical or an aqueous dispersion of water-dispersible oil or gas field production chemical, and a well-defined wall comprising a degradable polymer wherein the microcapsule has a diameter of less than 10 microns, preferably less than 5 microns, more preferably less than 1 micron.

The invention will now be illustrated by means of the following examples.

### EXAMPLES

Stage 1—Preparation of the Water in Primary Oil Emulsion

0.13 g to 0.5 g of polymer granules were weighed into a 25 ml glass beaker containing a Teflon coated magnetic flea. The polymer was either Eudragit RS100™ or Eudragit RL100™ (ex Rohm) i.e. copolymers of ethyl acrylate, methyl methacrylate and a quaternised acrylate wherein the quaternary ammonium group is CH₂—CH₂—N⁺(CH₃)₃Cl⁻. A volatile organic solvent comprising ethanol and dichoromethane (3 g ethanol and 2 g of dichloromethane) was added to the beaker and the resulting mixture was then gently stirred on a magnetic stirrer to allow the polymer to dissolve in the volatile organic solvent thereby generating a primary oil phase. 100 ml of an aqueous phase containing Tween 80 (0.25% wt/v, ex Uniqema) and scale inhibitor (Bellasol S50™, ex Biolabs, ca., 50 wt % solid content, 10% wt/v,) was added to the beaker containing the primary oil phase at room temperature with continuous stirring over 20 seconds thereby forming a water in primary oil emulsion. As indicated in the Tables below, in some experiments, the low shear stirring (with a magnetic flea) was replaced with mixing using a high shear mixer (Janne and Kunkel UltraTurrax T25).

Stage 2—Preparation of the Microparticles

The water in primary oil emulsion was slowly added with continuous stirring (using a variety of paddle stirrers operated at 0 to 350 rpm or a Janne and Kunkel UltraTurrax T25 high shear mixer operated at 24,000 rpm) to a 1 litre beaker containing a blend of 500 ml to 1000 ml of corn oil (food grade) and Span 80 surfactant (ex Uniqema, 0.02% wt/v). This mixture was stirred for 1 hour using the same stirring regime and shear rate as employed during the addition stage and hardened microparticles were subsequently collected by vacuum filtration through 0.45 μm Millipore filters. Optionally, the stirred mixture was subjected to ultrasonication. The collected microparticles were washed three times with n-hexane by suspending the microparticles in the n-hexane, allowing the microparticles to settle and decanting the n-hexane. The microparticles were allowed to soak in each aliquot of hexane with gentle shaking for 24 hours. The microparticles were then separated from the hexane by filtration and dried in an oven overnight at a temperature of 50° C.

The dried microparticles were then suspended in distilled water containing 0.02 g per ml of Tween 80 and then diluted into a larger volume of distilled water for particle sizing. The particle size of the suspended microparticles was determined using a MicroTrac UPA 150 laser particle sizer. The influence of various experimental parameters are shown in Tables 1 to 7 below (in all cases, the sizes are volume weighted diameters):

TABLE 1
Effect of polymer

| Polymer Type | Eudragit RS100 ™ | | Eudragit RL100 ™ | |
|---|---|---|---|---|
| Ultrasonication during | Yes | | | |
| Stage 2 | | | | |
| Wt of polymer used/g | 0.5 | 0.25 | 0.5 | 0.25 |
| Particle Size after | 43.3 | 13.8, 18.4 | 33.29 | 23.17 |
| Ultrasonication | | (16.1) | | |
| d50 | | | | |

TABLE 2
Effect of Ultrasonication

| | |
|---|---|
| Polymer Type | Eudragit RS100 ™ |

| | | |
|---|---|---|
| Wt of polymer used/g | 0.5 | 0.5 |
| Ultrasonication during | Yes | No |
| Stage 2 | | |
| Particle Size after | 43.3 | 83.74 |
| ultrasonication | | |
| d50 | | |

TABLE 3
Effect of corn oil volume

| | |
|---|---|
| Polymer Type | Eudragit RS100 ™ |
| Ultrasonication during | Yes |
| Stage 2 | |

| | | |
|---|---|---|
| Wt of polymer (g) | 0.5 | 0.5 |
| Volume of Corn oil (ml) | 500 | 1000 |
| Particle Size after | 13.80 | 14.17 |
| ultrasonication | | |
| d50 | | |

TABLE 4
Effect of polymer weight

| Polymer Type | Eudragit RS100 ™ | | |
|---|---|---|---|
| Ultrasonication during | Yes | | |
| Stage 2 | | | |
| Wt of polymer (g) | 0.5 | 0.25 | 0.13 |
| Particle Size after | 43.3 | 13.8, 18.4 | 13.14 |
| ultrasonication | | (16.1) | |
| d50 | | | |

TABLE 5
Effect of stirrer type

| Polymer Type | Eudragit RS100 ™ | | | |
|---|---|---|---|---|
| Wt of polymer (g) | 0.5 | | | |
| Ultrasonication during | Yes | | | |
| Stage 2 | | | | |
| Stirrer Type during | Screw | Paddle | Winged | UltraTurrax |
| Stage 2 | Propeller | 250 rpm | Screw | T25 |
| | 250 rpm | | Propeller | 24000 rpm |
| | | | 250 rpm | |
| Particle Size after | 27.01, 32.55 | 43.3 | 22.31 | 18.97 |
| ultrasonication | (29.78) | | | |
| d50 | | | | |

TABLE 6
Effect of stirrer speed during Stage 2

| | |
|---|---|
| Polymer Type | Eudragit RS100 ™ |
| Wt of polymer (g) | 0.5 |
| Ultrasonication during | Yes |
| Stage 2 | |
| Stirrer Type | Paddle |

| | | | | |
|---|---|---|---|---|
| Stirrer Speed (rpm) | 0 | 100 | 250 | 350 |
| Particle Size after | 85.39 | 176.2 | 43.3 | 53.34 |
| ultrasonication | | | | |
| d50 | | | | |

TABLE 7
Effect of high shear mixing during Stage 2

| Polymer Type | Eudragit RS100 ™ | |
|---|---|---|
| Wt of polymer (g) | 0.5 | 0.5 |
| Shear rate during Stage 1 | Low (stirred using a magnetic flea) | |
| Ultrasonication during | Yes | |
| Stage 2 | | |
| Stirrer type used in Stage | Paddle 250 rpm | Ultra Turrax T25 24000 rpm |
| 2 | | |
| Shear Rate | Low | High |
| Particle Size after U/S | 43.3 | 18.97 |
| d50 | | |

TABLE 7
Effect of shear rate during Stage 1; low shear mixing during Stage 2

| Polymer Type | Eudragit RS100 ™ | | | | |
|---|---|---|---|---|---|
| Wt of polymer (g) | 0.5 | | 0.5 | 0.5 | 0.26 |
| Ultrasonication | Yes | | | | |
| during Stage 2 | | | | | |
| Stirrer type used | UltraTurrax T25 | | | | |
| in Stage 1 | | | | | |
| Shear Rate during | <500 | 8000 | 13500 | 24000 | 24000 |
| Stage 1 (rpm) | | | | | |
| Shear Rate during | 250 | 250 | 250 | 250 | 250 |
| Stage 2 | | | | | |
| (paddle stirrer) | | | | | |
| Particle Size after | 43.30 | 48.38 | 27.40 | 19.80 | 16.37 |
| ultrasonication | | | | | |
| d50 | | | | | |

For the final set of experiments utilizing an UltraTurrax high shear mixer operated at 24,000 rpm during Stage 1, examination of the suspensions under a light microscope showed that the majority of the particles had diameters in the region of 2 to 3 μm with a number of poorly dispersed agglomerates of individual particles being present.

### Example 2

Stage 1—Preparation of the Water in Oil Emulsion

An oil phase comprising a solution of 5% (wt/vol) polylactide-co-glycolide polymer (ex Aldrich, molecular weight 65,000, with monomer ratios of 75-25 lactide to 100 glycoside) in dichloromethane was prepared and 10 ml of this oil phase was measured into a 25 ml glass bottle. To this glass bottle was added, by pipette, 0.02 g of Span 80 (ex Uniquema) followed by 1 ml of primary aqueous phase comprising a 30 % w/v aqueous solution of scale inhibitor (sodium polyacrylic acid, molecular weight 2,100, ex Aldrich). The resulting mixture was subjected to high shear mixing using a Janne and Kunkel Ultraturrax T25 high shear mixer for 5 min (at a shear rate of 8000 rpm) to give a water in oil emulsion.

Stage 2—Preparation of Microparticles

The water in oil emulsion from Stage 1 was transferred into a 75 ml glass bottle. A secondary aqueous phase comprising 50 ml of a 5% (wt/vol) aqueous solution of polyvinyl alcohol (ex Aldrich, 13,000 molecular weight, 87-89% hydrolysed) was prepared. To this secondary aqueous phase was added, 0.1 g of Tween 80 (ex Uniqema). The blend of the secondary aqueous phase and Tween 80 was added to the 75 ml bottle containing the water in oil emulsion and the resulting mixture was subjected to high shear mixing for 5 min using a Janne and Kunkel Ultraturrax T25 mixer (shear rate of 8,000 rpm) to form a water in oil in water double emulsion. This emulsion was transferred to a conical flask containing a Teflon coated magnetic flea and was stirred overnight on a magnetic stirrer under reduced pressure (with the flask attached to a laboratory vacuum line). The resulting suspension of microparticles was transferred to centrifuge tubes and the particles isolated from the mother liquor by centrifugation at 4000× g for 10 minutes. The sedimented microparticles were then separated from the mother liquor by vacuum filtration using a 0.45 μm Millipore filter. The particles were washed three times with deionised water during the filtration process using ca. 300 ml aliquots. The recovered particles were then dried in an oven at a temperature of 50° C. for several hours. The dried microparticles were then suspended in distilled water containing 0.02 g per ml of Tween 80 and then diluted into a larger volume of distilled water for particle sizing. The particle size of the suspended microparticles was determined using a MicroTrac UPA 150 laser particle sizer. The size distribution (volume weighted diameter) obtained was as follows:

D10 (μm)=1.57

D50 (μm)=4.90

D90 (μm)=67.51

Examination of the suspension under a light microscope showed that the majority of the microparticles had diameters in the region of 1 to 2 μm.

1-31. (canceled)

32. A method of introducing an oil or gas field production chemical into a subterranean formation comprising:
(a) injecting a suspension comprising microparticles suspended in a liquid medium into a formation through an injection well wherein the microparticles have a mean diameter of less than 1 micron and wherein the microparticles comprise an aqueous phase comprising an aqueous solution of a water-soluble oil or gas field production chemical or an aqueous dispersion of water-dispersible oil gas or gas field production chemical encapsulated in a continuous polymeric phase, and the polymer forming the continuous polymer phase is degradable under the conditions encountered in the formation;
(b) allowing the suspension to percolate through the formation towards a production well; and
(c) controllably releasing the aqueous solution of the water-soluble oil or gas field production chemical or the aqueous dispersion of the water-dispersible oil or gas field production chemical from the microparticles into the formation and/or the production well through degradation of the polymer forming the continuous polymeric phase.

33. A method as claimed in claim 32 wherein the microparticles have a mean diameter in the range 100-750 nm.

34. A method as claimed in claim 32 wherein the suspension propagates through the formation at a rate of 15 to 100 feet per day.

35. A method as claimed in claim 32 wherein the injection well is 0.25 to 1 mile from the production well.

36. A method as claimed in claim 32 wherein the suspension is injected down the injection well at a temperature of less than 10° C.

37. A method as claimed in claim 32 wherein the microparticles start to release the aqueous solution or aqueous dispersion of the oil or gas field production chemical at a threshold temperature in the range 50 to 150° C.

38. A method as claimed in claim 32 wherein the temperature of the injected suspension increases at a rate of 1 to 10° C. per 100 feet in the radial direction from the injection well towards the production well.

39. A method as claimed in claim 32 wherein the microparticles release substantially all of the aqueous solution or aqueous dispersion of the oil or gas field production chemical in the near wellbore region of the production well.

40. A method as claimed in claim 32 wherein the microparticles are dispersed in the liquid medium in an amount of from 20 to 50% by weight.

41. A method as claimed in claim 32 wherein the oil or gas field production chemical is dissolved or dispersed in the internal aqueous phase of the microparticles in an amount in the range of from 1 to 50 percent by weight, preferably 5 to 30 percent by weight.

42. A method as claimed in claim 32 wherein the oil or gas field production chemical is selected from the group consisting of water-soluble or water-dispersible (i) scale inhibitors, (ii) corrosion inhibitors, (iii) hydrogen sulphide scavengers and hydrate inhibitors.

43. A method as claimed in claim 32 wherein the liquid medium of the suspension is selected from the group consisting of an oil, an organic solvent and water.

44. A method as claimed in claim 43 wherein the liquid medium is a water dispersible organic solvent selected from the group consisting of methyl butyl ether, butyl monoglycol ether and biodegradable esters.

45. A method as claimed in claim 32 wherein the suspension of microparticles is continuously or intermittently dosed into the injection water.

46. A method as claimed in claim 45 wherein the production chemical is a scale inhibitor and the amount of scale inhibitor released into water production from the production well is in the range 1 to 200 ppm.

47. A method as claimed in claim 32 wherein the microparticles are microcapsules or microspheres.

48. A method as claimed in claim 47 wherein the microcapsules comprise a well-defined core of the aqueous solution of the water-soluble oil or gas field production chemical or of the aqueous dispersion of the water-dispersible oil or gas field production chemical, and a well-defined wall comprising the degradable polymer.

49. A method as claimed in claim 47 wherein the microspheres comprise a continuous polymeric matrix comprising the degradable polymer encapsulating the aqueous solution or aqueous dispersion at either a macroscopic or molecular level.

50. A method as claimed in claim 49 wherein the polymeric matrix is porous or non-porous.

51. A method as claimed in claim 49 wherein a plurality of droplets of the aqueous solution or aqueous dispersion are encapsulated in the polymer matrix.
